(19) United States
(12) Patent Application Publication
(10) Pub. No.: US 2012/0009338 A1
(43) Pub. Date: Jan. 12, 2012

(54) METHOD FOR PRODUCING PLASMA DISPLAY PANEL

(76) Inventors: Eiji Takeda, Osaka (JP); Takuji Tsujita, Osaka (JP); Jun Hashimoto, Osaka (JP); Masashi Gotou, Osaka (JP)

(21) Appl. No.: 13/148,152

(22) PCT Filed: Mar. 16, 2011
(86) PCT No.: PCT/JP2011/001528

§ 371 Date: Aug. 5, 2011

(30) Foreign Application Priority Data
Mar. 26, 2010 (JP) 2010-071979

(51) Int. Cl. B05D 5/06; B05D 3/02

(52) U.S. Cl. 427/162

(57) ABSTRACT

A method for producing a plasma display panel having a base layer including metallic oxides and agglomerated particles dispersed on the base layer includes the following steps of: forming the base layer on the dielectric layer; spreading a first organic solvent on the base layer to form a first coating layer; spreading a second organic solvent in which the agglomerated particles are dispersed on the first coating layer to form a second coating layer; and heating the first and second coating layers to evaporate the first and second organic solvents and further to disperse the agglomerated particles on the base layer.

### TECHNICAL FIELD

The technology disclosed herein relates to a method for producing a plasma display panel used in, for example, a display device.

### BACKGROUND ART

A plasma display panel (hereinafter, called PDP) has a front plate and a rear plate. The front plate includes a glass substrate, display electrodes formed on a main surface of the glass substrate, a dielectric layer covering the display electrodes to function as a capacitor, and a protective layer made of magnesium oxide (MgO) formed on the dielectric layer. Meanwhile, the rear plate includes a glass substrate, data electrodes formed on a main surface of the glass substrate, a base dielectric layer covering the data electrodes, barrier ribs formed on the base dielectric layer, and phosphor layers respectively formed between the barrier ribs to emit red, green, and blue light.

The front plate and the rear plate are air-tightly sealed to each other with their electrode-formed surfaces facing each other. A discharge gas containing neon (Ne) and xenon (Xe) is enclosed in a discharge space divided by the barrier ribs. The discharge gas is electrically discharged to generate light when a video signal voltage is selectively applied to the display electrodes. The electric discharge generates ultraviolet light, and the generated ultraviolet light excites the phosphor layers. The excited phosphor layers respectively emit the red, green, and blue light. This is the mechanism of a color image display in PDP (see Patent Document 1).

There are four main functions exerted by the protective layer; 1) protect the dielectric layer from the impact of ions through the electric discharge, 2) release primary electrons to cause data discharge, 3) retain charges for causing the electric discharge, and 4) release secondary electrons during sustain discharge. Because the dielectric layer is protected from the ion-induced impact, a discharge voltage is prevented from increasing. As more primary electrons are released, a data discharge error, which is a factor responsible for flickering images, is reduced. Improvement of a charge retainability lowers a voltage to be applied, and increase of secondary electrons to be released lowers a sustain discharge voltage. An attempt for increasing the primary electrons to be released is to add, for example, silicon (Si) or aluminum (Al) to MgO of the protective layer (for example, see Patent Documents 1, 2, 3, 4, and 5).

### PRIOR ART DOCUMENTS

### Patent Documents

Patent Document 1: Unexamined Japanese Patent Publication No. 2002-260535
Patent Document 2: Unexamined Japanese Patent Publication No. 11-339665
Patent Document 3: Unexamined Japanese Patent Publication No. 2006-59779
Patent Document 4: Unexamined Japanese Patent Publication No. 08-236028
Patent Document 5: Unexamined Japanese Patent Publication No. 10-334809

### DISCLOSURE OF THE INVENTION

The present invention provides a method for producing a PDP having a rear plate and a front plate sealed to the rear plate with a discharge space interposed therebetween. The front plate includes a dielectric layer and a protective layer which covers the dielectric layer. The protective layer includes a base layer formed on the dielectric layer. Agglomerated particles in which crystal particles of magnesium oxide are agglomerated to one another are dispersed evenly on an entire surface of the base layer. The base layer includes at least a first metallic oxide and a second metallic oxide. The base layer further has at least a peak through an X-ray diffraction analysis. The peak of the base layer is present at an intermediate position between a first peak through an X-ray diffraction analysis of the first metallic oxide and a second peak through an X-ray diffraction analysis of the second metallic oxide. The first peak and the second peak indicate a plane orientation equal to a plane orientation indicated by the peak of the base layer. The first metallic oxide and the second metallic oxide are two selected from a group consisting of magnesium oxide, calcium oxide, strontium oxide, and barium oxide.

The method for producing the PDP includes the steps of forming the base layer on the dielectric layer; forming a first coating layer on the base layer by spreading a first organic solvent; forming a second coating layer on the first coating layer by spreading a second organic solvent in which agglomerated particles are dispersed; heating the first and second coating layers to evaporate the first organic solvent and the second organic solvent and further to disperse the agglomerated particles on the base layer.

### BRIEF DESCRIPTION OF THE DRAWINGS

FIG. 1 is a perspective view illustrating a structure of PDP according to an embodiment.

FIG. 2 is a sectional view illustrating a structure of a front plate according to the embodiment.

FIG. 3 is a flow chart illustrating PDP production steps according to the embodiment.

FIG. 4 is a graph illustrating X-ray diffraction analysis results obtained from a surface of a base film according to the embodiment.

FIG. 5 is a graph illustrating X-ray diffraction analysis results obtained from a surface of another base film according to the embodiment.

FIG. 6 is an enlarged view of agglomerated particles according to the embodiment.

FIG. 7 is a graph illustrating a relationship between a discharge delay and a calcium (Ca) concentration in a protective layer in the PDP according to the embodiment.

FIG. 8 is a graph illustrating a relationship between an electron releasability and a Vscn lighting voltage in the PDP.

FIG. 9 is a graph illustrating a relationship between the electron releasability and an average particle diameter of the agglomerated particles according to the embodiment.

FIG. 10 is a graph illustrating a relationship between a barrier rib breakage probability and the average particle diameter of the agglomerated particles according to the embodiment.

FIG. 11 is a flow chart illustrating protective layer formation steps according to the embodiment.

FIG. 12 is a pictorial drawing of the protective layer formation steps according to the embodiment.

### PREFERRED EMBODIMENTS FOR CARRYING OUT OF THE INVENTION

### [1. Basic Structure of PDP]

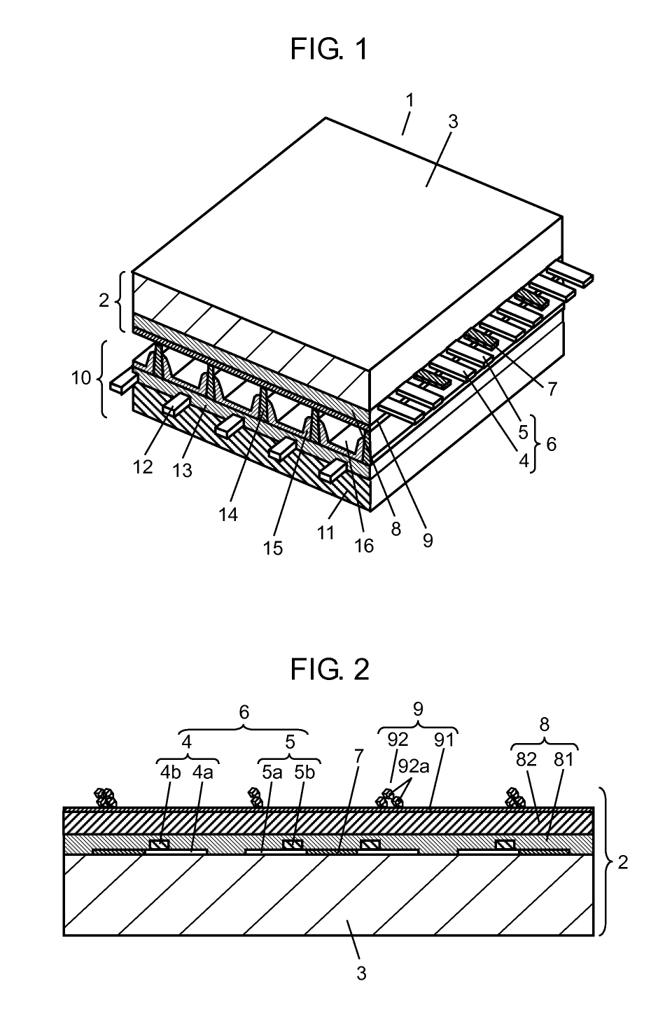

A basic structure of PDP is a general AC surface discharge PDP. As illustrated in FIG. 1, PDP 1 has a structure where front plate 2 including front glass substrate 3 and rear plate 10 including rear glass substrate 11 are disposed facing each other. Outer peripheral portions of front plate 2 and rear plate 10 are air-tightly sealed to each other by a sealing member made of, for example, glass frit. A discharge gas containing, for example, Ne and Xe is enclosed in discharge space 16 formed in PDP 1 by the sealed plates under a pressure in the range of 53 kPa to 80 kPa.

A plurality of pairs of band-shape display electrodes 6 each including scan electrode 4 and sustain electrode 5 and a plurality of black stripes 7 are provided on front glass substrate 3 in parallel with each other. Dielectric layer 8 functioning as a capacitor is formed on front glass substrate 3 so as to cover display electrodes 6 and black stripes 7. A surface of dielectric layer 8 is coated with protective layer 9 made of, for example, MgO. As illustrated in FIG. 2, protective layer 9 according to the embodiment includes base film 91 which is a base layer provided on dielectric layer 8, and agglomerated particles 92 which adhere to a surface of base film 91.

Scan electrodes 4 and sustain electrodes 5 are transparent electrodes made of an electrically conductive metallic oxide such as indium tin oxide (ITO), tin dioxide (SnO₂), or zinc oxide (ZnO) on which bus electrodes containing Ag are formed.

A plurality of data electrodes 12 made of an electrically conductive material containing silver (Ag) as its principal ingredient is formed on rear glass substrate 11 in parallel with each other in a direction orthogonal to display electrodes 6. Data electrodes 12 are coated with base dielectric layer 13. Barrier ribs 14 are formed to a predetermined height on base dielectric layer 13 between data electrodes 12 to divide discharge space 16. Phosphor layers are sequentially formed on base dielectric layer 13 and side surfaces of barrier ribs 14 for each of data electrodes 12, the phosphor layers are respectively; phosphor layer 15 which emits red light, phosphor layer 15 which emits green light, and phosphor layer 15 which emits blue light, each layer emitting light in response to ultraviolet light. A discharge cell is formed at a position where display electrode 6 and data electrode 12 intersect with each other. The discharge cells respectively having red, green, and blue phosphor layers 15 arranged in the direction of display electrodes 6 constitute color display pixels.

In the present embodiment, the discharge gas enclosed in discharge space 16 includes Xe by no less than 10 vol. % and no more than 30 vol. %.

### [2. PDP Production Method]

Next, a method for producing PDP 1 is described.

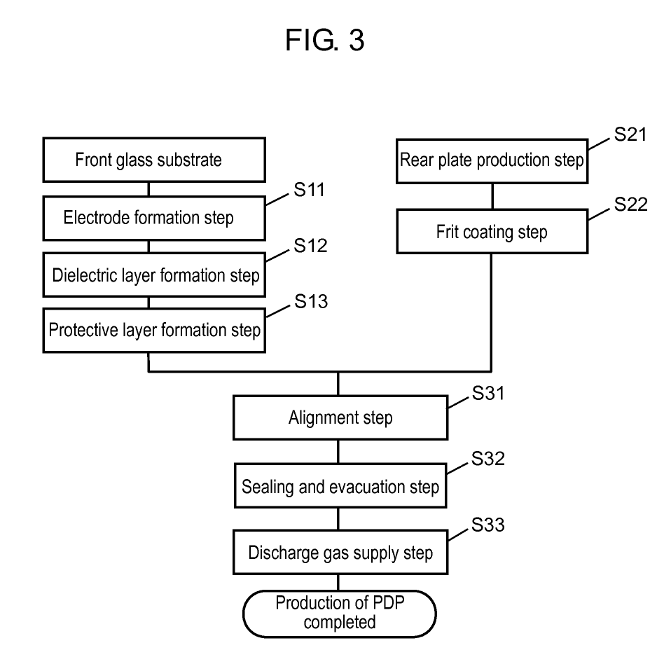

First, a method for producing front plate 2 is described. In electrode formation step S11, scan electrodes 4, sustain electrodes 5, and black stripes 7 are formed on front glass substrate 3 by photolithography as illustrated in FIG. 3. Scan electrodes 4 and sustain electrodes 5 respectively have bus electrodes 4b and 5b including Ag to ensure an electrical conductivity. Scan electrodes 4 and sustain electrodes 5 further include transparent electrodes 4a and 5a, respectively. Bus electrodes 4b are provided on transparent electrodes 4a, and bus electrodes 5b are provided on transparent electrodes 5a.

A material such as ITO is used to form transparent electrodes 4a and 5a to ensure a degree of transparency and an electrical conductivity. First, an ITO thin film is formed on front glass substrate 3 by sputtering. Then, transparent electrodes 4a and 5a are formed in a predetermined pattern by lithography.

A material used to form bus electrodes 4b and 5b is, for example, a white paste containing a glass frit, a photosensitive resin, and a solvent to increase an Ag—Ag binding capacity. First, the white paste is spread on front glass substrate 3 by screen printing, and the solvent in the white paste is removed in a baking oven. Next, the while paste is exposed to light via a photo mask formed in a predetermined pattern.

Then, the white paste is developed so that a bus electrode pattern is formed. Lastly, the bus electrode pattern is fired in a baking oven at a predetermined temperature so that the photosensitive resin in the bus electrode pattern is removed. Further, the glass frit in the bus electrode pattern is melted as the bus electrode pattern is fired, and the melted glass frit starts to vitrify again after the firing is over. As a result of these steps, bus electrodes 4b and 5b are formed.

Black stripes 7 are formed from a material including a black pigment. Black stripes 7 are formed between display electrodes 6 by, for example, screen printing.

Then, dielectric layer 8 is formed in dielectric layer formation step S12. A material used to form dielectric layer 8 is, for example, a dielectric paste including a dielectric glass frit, a resin, and a solvent. First, the dielectric paste is spread in a predetermined thickness on front glass substrate 3 by die coating so as to cover scan electrodes 4, sustain electrodes 5, and black stripes 7. Next, the solvent in the dielectric paste is removed in a baking oven. Lastly, the dielectric paste is fired in a baking oven at a predetermined temperature so that the resin in the dielectric paste is removed. Further, the dielectric glass frit is melted as the dielectric paste is fired, and the melted dielectric glass frit starts to vitrify again after the firing is over. As a result of step S12, dielectric layer 8 is formed. In place of die coating employed to apply the dielectric paste, screen printing or spin coating may be employed. Instead of using the dielectric paste, a film used as dielectric layer 8 may be formed by CVD (Chemical Vapor Deposition). Dielectric layer 8 will be described in detail later.

In protective layer formation steps S13, protective layer 9 including base film 91 and agglomerated particles 92 is formed on dielectric layer 8. Protective layer 9 and protective layer formation steps S13 will be described in detail later.

As a result of steps S11 to S13 described so far, scan electrodes 4, sustain electrodes 5, black stripes 7, dielectric layer 8, and protective layer 9 are formed on front glass substrate 3, and the production of front plate 2 is completed.

Next, rear plate production step S21 is described. Data electrodes 12 are formed on rear glass substrate 11 by photolithography. A material used to form data electrodes 12 is, for example, a data electrode paste containing a glass frit, a photosensitive resin, and a solvent to increase an Ag—Ag binding capacity for ensuring an electrical conductivity. First, the data electrode paste is spread in a predetermined thickness on rear glass substrate 11 by screen printing, and the solvent in the data electrode paste is removed in a baking oven. Then, the data electrode paste is exposed to light via a photo mask formed in a predetermined pattern. Then, the data electrode paste is developed so that a data electrode pattern is formed. Lastly, the data electrode pattern is fired in a baking oven at a predetermined temperature so that the photosensitive resin in the data electrode pattern is removed. Further, the glass frit in the data electrode pattern is melted as the data electrode pattern is fired, and the melted glass frit starts to vitrify again after the firing is over. As a result of these steps, data electrodes 12 are formed. In place of screen printing employed to apply the data electrode paste, sputtering or vapor deposition may be employed.

Then, base dielectric layer 13 is formed. A material used to form base dielectric layer 13 is, for example, a base dielectric paste containing a dielectric glass frit, a resin, and a solvent. First, the base dielectric paste is spread in a predetermined thickness by screen printing on rear glass substrate 11 having data electrodes 12 formed thereon so as to cover data electrodes 12. Then, the solvent in the base dielectric paste is removed in a baking oven. Lastly, the base dielectric paste is fired at a predetermined temperature in a baking oven so that the resin in the base dielectric paste is removed. Further, the dielectric glass frit is melted as the base dielectric paste is fired, and the melted glass frit starts to vitrify again after the firing is over. As a result of these steps, base dielectric layer 13 is formed. In place of screen printing employed to apply the base dielectric paste, die coating or spin coating may be employed. Instead of using the base dielectric paste, a film used as base dielectric layer 13 may be formed by, for example, CVD.

Next, barrier ribs 14 are formed by photolithography. A material used to form barrier ribs 14 is, for example, a barrier rib paste containing a filler, a glass frit as a filler binding agent, a photosensitive resin, and a solvent. The barrier rib paste is spread on base dielectric layer 13 in a predetermined thickness by die coating. Then, the solvent in the barrier rib paste is removed in a baking oven, and the barrier rib paste is exposed to light via a photo mask formed in a predetermined pattern. The barrier rib paste is then developed so that a barrier rib pattern is formed. Lastly, the barrier rib pattern is fired at a predetermined temperature in a baking oven so that the photosensitive resin in the barrier rib pattern is removed. Further, the glass frit in the barrier rib pattern is melted as the barrier rib pattern is fired, and the melted glass frit starts to vitrify again after the firing is over. As a result of these steps, barrier ribs 14 are formed. The photolithography may be replaced with sandblasting.

Next, phosphor layers 15 are formed. A material used to form phosphor layer 15 is, for example, a phosphor paste including a phosphor, a binder, and a solvent. First, the phosphor paste is spread by dispensing in a predetermined thickness on base dielectric layer 13 between adjacent barrier ribs 14 and side surfaces of barrier ribs 14. Then, the solvent in the phosphor paste is removed in a baking oven. Lastly, the phosphor paste is fired at a predetermined temperature in a baking oven so that the resin in the phosphor paste is removed. So far described is the formation process of phosphor layer 15. The dispensing may be replaced with screen printing or inkjetting.

As a result of rear plate production step S21 described so far, the production of rear plate 10 provided with the required structural elements on rear glass substrate 11 is completed.

In frit coating step S22, a sealing member (not illustrated in the drawings) is formed in a peripheral portion of rear plate 10 by dispensing. A material of the sealing member (not illustrated in the drawings) is a sealing paste containing a glass frit, a binder, and a solvent. Then, the solvent in the sealing paste is removed in a baking oven.

Then, front plate 2 and rear plate 10 are put together. In alignment step S31, front plate 2 and rear plate 10 are disposed facing each other so that display electrodes 6 and data electrodes 12 are orthogonal to each other.

In sealing and evacuation step S32 that follows, peripheral portions of front plate 2 and rear plate 10 are sealed by a glass frit, and air is evacuated from discharge space 16.

In discharge gas supply step S33 which is the last step, the discharge gas containing Ne and Xe is enclosed in discharge space 16.

The production of PDP 1 is completed through the above steps.

### [3. Details of Dielectric Layer]

Dielectric layer 8 is described in detail. First dielectric layer 81 and second dielectric layer 82 constitute dielectric layer 8. A dielectric material of first dielectric layer 81 includes the following components; dibismuth trioxide (Bi₂O₃) by 20 wt. % to 40 wt. %, at least one selected from a group consisting of calcium oxide (CaO), strontium oxide (SrO), and barium oxide (BaO) by 0.5 wt. % to 12 wt. %, and at least one selected from a group consisting of molybdenum trioxide (MoO₃), tungsten trioxide (WO₃), cerium dioxide (CeO₂), and manganese dioxide (MnO₂) by 0.1 wt. % to 7 wt. %.

In place of the group consisting of MoO₃, WO₃, CeO₂, and MnO₂, at least one selected from a group consisting of copper oxide (CuO), dichrome trioxide (Cr₂O₃), cobalt trioxide (CO₂O₃), divanadium heptoxide (V₂O₇), and diantimony trioxide (Sb₂O₃) may be included by 0.1 wt. % to 7 wt. %.

Other than the foregoing components, any of the following components not containing lead may be included; ZnO by 0 wt. % to 40 wt. %, diboron trioxide (B₂O₃) by 0 wt. % to 35 wt. %, silicon dioxide (SiO₂) by 0 wt. % to 15 wt. %, and aluminum trioxide (Al₂O₃) by 0 wt. % to 10 wt. %.

To produce the powderized dielectric material, the dielectric material is ground by a wet jet mill or a ball mill so that an average particle diameter is 0.5 μm to 2.5 μm. When the powderized dielectric material by 55 wt. % to 70 wt. % and a binder component by 30 wt. % to 45 wt. % are kneaded well by a three-roll mill, a paste for first dielectric layer used in die coating or printing is obtained.

The binder component is ethyl cellulose, or terpineol or butyl carbitol acetate including acrylic resin by 1 wt. % to 20 wt. %. If necessary, dioctyl phthalate, dibutyl phthalate, triphenyl phosphate, or tributyl phosphate may be further added to the paste as a plasticizer, and glycerol mono-oleate, sorbitan sesquioleate, HOMOGENOL (product supplied by Kao Corporation), alkylaryl phosphate, or the like may be further added to the paste as a dispersant. The addition of the dispersant improves a level of printability.

The paste for first dielectric layer is printed on front glass substrate 3 by die coating or screen printing so as to cover display electrodes 6. The paste for first dielectric layer thus printed is dried and then fired at 575° C. to 590° C. slightly higher than the softening point of the dielectric material so that first dielectric layer 81 is formed.

Next, second dielectric layer 82 is described. A dielectric material of second dielectric layer 82 includes the following components; Bi₂O₃ by 11 wt. % to 20 wt. %, at least one selected from CaO, SrO, and BaO by 1.6 wt. % to 21 wt. %, and at least one selected from a group consisting of MoO₃, WO₃, and CeO₂ by 0.1 wt. % to 7 wt. %.

In place of MoO₃, WO₃, and CeO₂, at least one selected from CuO, Cr₂O₃, Co₂O₃, V₂O₇, Sb₂O₃, and MnO₂ may be included by 0.1 wt. % to 7 wt. %.

Other than the foregoing components, any of the following components not containing lead may be included; ZnO by 0 wt. % to 40 wt. %, B₂O₃ by 0 wt. % to 35 wt. %, SiO₂ by 0 wt. % to 15 wt. %, and Al₂O₃ by 0 wt. % to 10 wt. %.

To produce the powderized dielectric material, the dielectric material is ground by a wet jet mill or a ball mill so that an average particle diameter is 0.5 μm to 2.5 μm. When the powderized dielectric material by 55 wt. % to 70 wt. % and a binder component by 30 wt. % to 45 wt. % are kneaded well by a three-roll mill, a paste for second dielectric layer used in die coating or printing is obtained.

The binder component is ethyl cellulose, or terpineol or butyl carbitol acetate including acrylic resin by 1 wt. % to 20 wt. %. If necessary, dioctyl phthalate, dibutyl phthalate, triphenyl phosphate, or tributyl phosphate may be further added to the paste as a plasticizer, and glycerol mono-oleate, sorbitan sesquioleate, HOMOGENOL (product supplied by Kao Corporation), alkylaryl phosphate, or the like may be further added to the paste as a dispersant. The addition of the dispersant improves a level of printability.

The paste for second dielectric layer is printed on first dielectric layer 81 by die coating or screen printing. The paste for second dielectric layer thus printed is dried and then fired at 550° C. to 590° C. slightly higher than the softening point of the dielectric material so that second dielectric layer 82 is formed.

To ensure a good transmission factor of visible light, dielectric layer 8 preferably has a film thickness no more than 41 μm with first dielectric layer 81 and second dielectric layer 82 altogether.

To control a reaction of bus electrodes 4b and 5b with Ag, a larger volume of Bi₂O₃ is included in first dielectric layer 81 than Bi₂O₃ included in second dielectric layer 82, more specifically, Bi₂O₃ is included in first dielectric layer 81 by 20 wt. % to 40 wt. %. This makes the visible light transmission factor of first dielectric layer 81 lower than that of second dielectric layer 82. Therefore, first dielectric layer 81 is formed in a smaller film thickness than second dielectric layer 82.

When Bi₂O₃ is included in second dielectric layer 82 by less than 11 wt. %, the possibility of color staining is lessened, however, air bubbles are more easily generated in second dielectric layer 82. Therefore, it is not preferable to include Bi₂O₃ by less than 11 wt. %. When the rate of content of Bi₂O₃ exceeds 40 wt. %, the possibility of color staining increases, deteriorating the visible light transmission factor. Therefore, it is not preferable to include Bi₂O₃ by more than 40 wt. %.

As the film thickness of dielectric layer 8 is smaller, such effects as improvement of a luminance level and reduction of a discharge voltage become more prominent. Therefore, it is desirable to make the film thickness of dielectric layer 8 as small as possible to such an extent that a breakdown voltage thereof is not thereby deteriorated.

In view of these technical aspects, the film thickness of dielectric layer 8 according to the present embodiment is no more than 41 μm, wherein first dielectric layer 81 has the film thickness of 5 μm to 15 μm, and second dielectric layer 82 has the film thickness of 20 μm to 36 μm.

It was confirmed that PDP 1 thus produced can control the color staining (turning yellow) of front glass substrate 3 and air bubbles generated in dielectric layer 8 regardless of Ag used in display electrodes 6, thereby significantly improving the breakdown voltage of dielectric layer 8.

Below is discussed why these dielectric materials can prevent first dielectric layer 81 from turning yellow and control the generation of air bubbles therein in PDP 1 according to the present embodiment. It is already known that such compounds as Ag₂MoO₄, Ag₂Mo₂O₇, Ag₂Mo₄O₁₃, Ag₂WO₄, Ag₂W₂O₇, and Ag₂W₄O₁₃ are more easily generated at low temperatures no more than 580° C. by adding MoO₃ or WO₃ to dielectric glass containing Bi₂O₃. According to the present embodiment wherein the firing temperature of dielectric layer 8 is 550° C. to 590° C., silver ions (Ag⁺) diffused in dielectric layer 8 during firing react with MoO₃, WO₃, CeO₂, and MnO₂ in dielectric layer 8 and generate stable compounds, thereby stabilizing Ag⁺. Thus, the stabilization can be accomplished without the reduction of Ag⁺, and such an unfavorable event is avoidable that Ag⁺ starts to agglomerate, generating colloids. The stabilization of Ag⁺ lessens oxygen generated by the collidization of Ag, thereby lessening air bubbles generated in dielectric layer 8.

To further improve these effects, MoO₃, WO₃, CeO₂, or MnO₂ is preferably included in the dielectric glass containing Bi₂O₃ by no less than 0.1 wt. %, and more preferably by no less than 0.1 wt. % and no more than 7 wt. % because the turning-yellow event is not very effectively prevented from happening if less than 0.1 wt. %, and the glass is unfavorably color-stained if more than 7 wt. %.

As described so far, dielectric layer 8 of PDP 1 according to the present embodiment is technically advantageous in that first electric layer 81 made of Ag and contacting bus electrodes 4b and 5b controls the turning-yellow event and the generation of air bubbles, and second dielectric layer 82 provided on first dielectric layer 81 helps to accomplish a high light transmission factor. As a result, PDP provided with dielectric layer 8 having such remarkable layers can prevent turning yellow, control the generation of air bubbles, and achieve a good light transmission factor.

### [4. Details of Protective Layer]

Protective layer 9 includes base film 91 which is a base layer and agglomerated particles 92. Base film 91 includes at least a first metallic oxide and a second metallic oxide. The first metallic oxide and the second metallic oxide are two selected from a group consisting of MgO, CaO, SrO, and BaO. Base film 91 further has at least a peak through an X-ray diffraction analysis. The peak is present at an intermediate position between a first peak through an X-ray diffraction analysis of the first metallic oxide and a second peak through an X-ray diffraction analysis of the second metallic oxide. The first peak and the second peak indicate a plane orientation equal to a plane orientation indicated by the peak of base film 91.

[4-1. Details of Base Film]

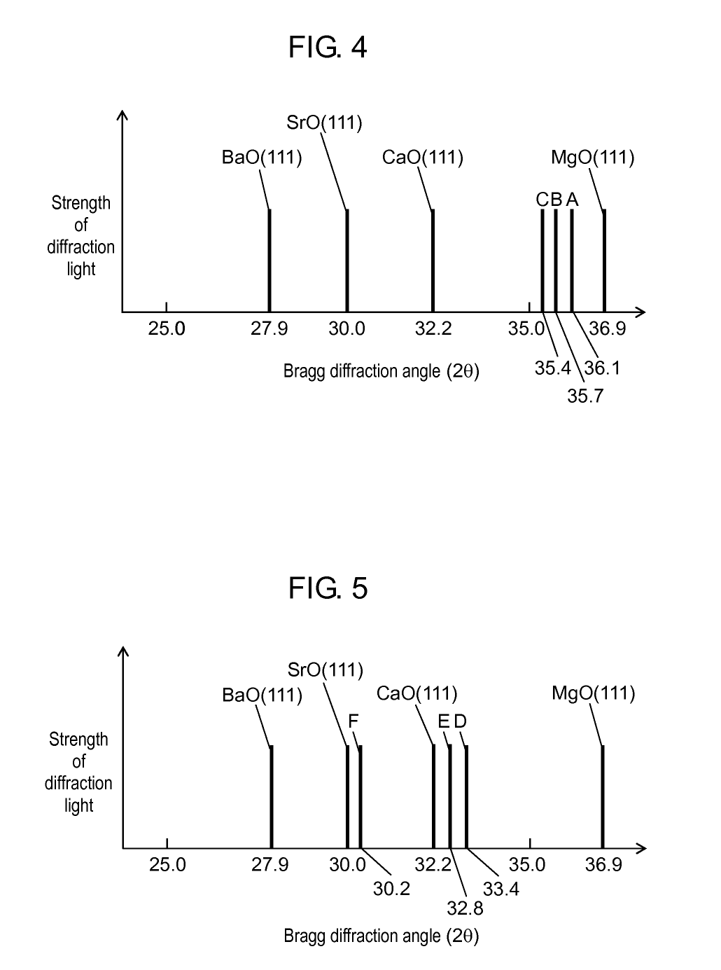

FIG. 4 illustrates X-ray diffraction analysis results obtained from the surface of base film 91 constituting protective layer 9 of PDP 1 according to the present embodiment. FIG. 4 further illustrates X-ray diffraction analysis results obtained from MgO, CaO, SrO, and BaO each singly used.

In FIG. 4, a lateral axis represents the Bragg diffraction angle (2θ), and a longitudinal axis represents the strength of an X-ray diffracted wave. The diffraction angle is expressed by 360 degrees in a full circle, and the strength is expressed by an arbitrary unit. A crystalline orientation plane, which is a specific orientation plane, is bracketed.

As illustrated in FIG. 4, CaO used as a single component in the plane orientation of (111) has a peak at the diffraction angle of 32.2 degrees. MgO used as a single component has a peak at the diffraction angle of 36.9 degrees. SrO used as a single component has a peak at the diffraction angle of 30.0 degrees. BaO used as a single component has a peak at the diffraction angle of 27.9 degrees.

In PDP 1 according to the present embodiment, base film 91 of protective layer 9 includes at least two metallic oxides selected from a group consisting of MgO, CaO, SrO, and BaO.

FIG. 4 illustrates X-ray diffraction results in the case where two single components constitute base film 91. Point A shows the X-ray diffraction result of base film 91 in which MgO and CaO are each used as a single component. Point B shows the X-ray diffraction result of base film 91 in which MgO and SrO are each used as a single component. Point C shows the X-ray diffraction result of base film 91 in which MgO and BaO are each used as a single component.

As illustrated in FIG. 4, Point A has a peak at the diffraction angle of 36.1 degrees in the plane orientation of (111). MgO alone constituting the first metallic oxide has a peak at the diffraction angle of 36.9 degrees. CaO alone constituting the second metallic oxide has a peak at the diffraction angle of 32.2 degrees. Therefore, the peak of Point A is present between the peaks of MgO and CaO each used as a single component. Similarly, Point B has a peak at the diffraction angle of 35.7 degrees, and Point B is present between the peaks of MgO constituting the first metallic oxide and SrO constituting the second metallic oxide each used as a single component. Point C has a peak at the diffraction angle of 35.4 degrees, and Point C is present between the peaks of MgO constituting the first metallic oxide and BaO constituting the second metallic oxide each used as a single component.

FIG. 5 illustrates X-ray diffraction results in the case where three single components constitute base film 91. Point D shows the X-ray diffraction result of base film 91 in which MgO, CaO, and SrO are each used as a single component. Point E shows the X-ray diffraction result of base film 91 in which MgO, CaO and BaO are each used as a single component. Point F shows the X-ray diffraction result of base film 91 in which CaO, SrO, and BaO are each used as a single component.

As illustrated in FIG. 5, Point D has a peak at the diffraction angle of 33.4 degrees in the plane orientation of (111). MgO alone constituting the first metallic oxide has a peak at the diffraction angle of 36.9 degrees. SrO alone constituting the second metallic oxide has a peak at the diffraction angle of 30.0 degrees. Therefore, the peak of Point D is present between the peaks of MgO and SrO each used as a single component. Similarly, Point E has a peak at the diffraction angle of 32.8 degrees, and Point E is present between the peaks of MgO constituting the first metallic oxide and BaO constituting the second metallic oxide each used as a single component. Point F has a peak at the diffraction angle of 30.2 degrees, and Point F is present between the peaks of CaO constituting the first metallic oxide and BaO constituting the second metallic oxide each used as a single component.

Therefore, base film 91 of PDP 1 according to the present embodiment includes at least the first metallic oxide and the second metallic oxide. Base film 91 further has at least a peak through an X-ray diffraction analysis. The peak is present at an intermediate position between a first peak through an X-ray diffraction analysis of the first metallic oxide and a second peak through an X-ray diffraction analysis of the second metallic oxide. The first peak and the second peak indicate a plane orientation equal to a plane orientation indicated by the peak of base film 91. The first metallic oxide and the second metallic oxide are two selected from a group consisting of MgO, CaO, SrO, and BaO.

In the description given so far, (111) is used as an example of the crystal orientation plane. In any other plane orientation, the peaks of the metallic oxides are similarly positioned.

Depths of CaO, SrO, and BaO based on a vacuum level are present in a relatively shallow region as compared to MgO. This is a probable cause of increase of electrons released by the Auger effect as compared to transition from the energy level of MgO when electrons present at energy levels of CaO, SrO, and BaO transit to the ground state of Xe ions to drive PDP 1.

As described earlier, the peak of base film 91 according to the present embodiment is present between the peak of the first metallic oxide and the peak of the second metallic oxide. Thus, the energy level of base film 91 is present between the metallic oxides each used as a single component. Therefore, electrons released by the Auger effect are likely to increase as compared to transition from the energy level of MgO.

Because of these facts, base film 91 can exert favorable secondary electron release characteristics as compared to MgO alone, thereby reducing the sustain voltage. When the partial pressure of Xe used as the discharge gas is elevated especially to increase the luminance level, therefore, the discharge voltage can be reduced. As a result, PDP 1 can succeed in the voltage reduction and improvement of the luminance level.

Table 1 shows a sustain voltage result when a mixed gas containing Xe and Ne (Xe by 15%) is enclosed under 60 kPa in PDP 1 according to the present embodiment in which the technical requirement of base film 91 is different.

TABLE 1

| | Sample | Sample | Sample | Sample | Sample | Comparative |
|---|---|---|---|---|---|---|
| | A | B | C | D | E | example |
| Sustain | 90 | 87 | 85 | 81 | 82 | 100 |
| voltage | | | | | | |
| (a.u.) | | | | | | |

The sustain voltage of Table 1 is expressed by relative values based on the value of Comparative Example “100”. Base film 91 of Sample A includes MgO and CaO. Base film 91 of Sample B includes MgO and SrO. Base film 91 of Sample C includes MgO and BaO. Base film 91 of Sample D includes MgO, CaO, and SrO. Base film 91 of Sample E includes MgO, CaO, and BaO. Base film 91 of Comparative Example includes MgO alone.

When the partial pressure of the discharge gas Xe is increased from 10% to 15%, the luminance level is improved by approximately 30%. In Comparative Example in which base film 91 includes MgO alone, the sustain voltage is elevated by approximately 10%.

In contrast, the PDP according to the present embodiment can reduce the sustain voltage in any of Sample A, Sample B, Sample C, Sample D, and Sample E by approximately 10% to 20% as compared to Comparative Example. Therefore, voltages within the range of a normal operation can be used to start the electrical discharge, and the PDP can achieve a low-voltage drive and a higher luminance level.

Any of CaO, SrO, and BaO has a high degree of reactivity when singly used, therefore, they easily react with an impurity, deteriorating a degree of electron releasability. The present embodiment, however, lessens the reactivity by using the metallic oxides described so far, and provides a crystalline structure in which contamination with an impurity and oxygen deficiency are more unlikely to occur. Therefore, it is prevented that electrons are overly released when the PDP is driven, and suitable charge retention characteristics can be accomplished as well as the other favorable effects which are the low-voltage drive and secondary electron releasability. The charge retention characteristics are advantageous in that wall charges stored in an initialization period are retained to avoid any address error in a address period so that a address discharge is reliably exercised.

[4-2. Details of Agglomerated Particles]

Next, agglomerated particles 92 provided on base film 91 according to the present embodiment are described in detail.

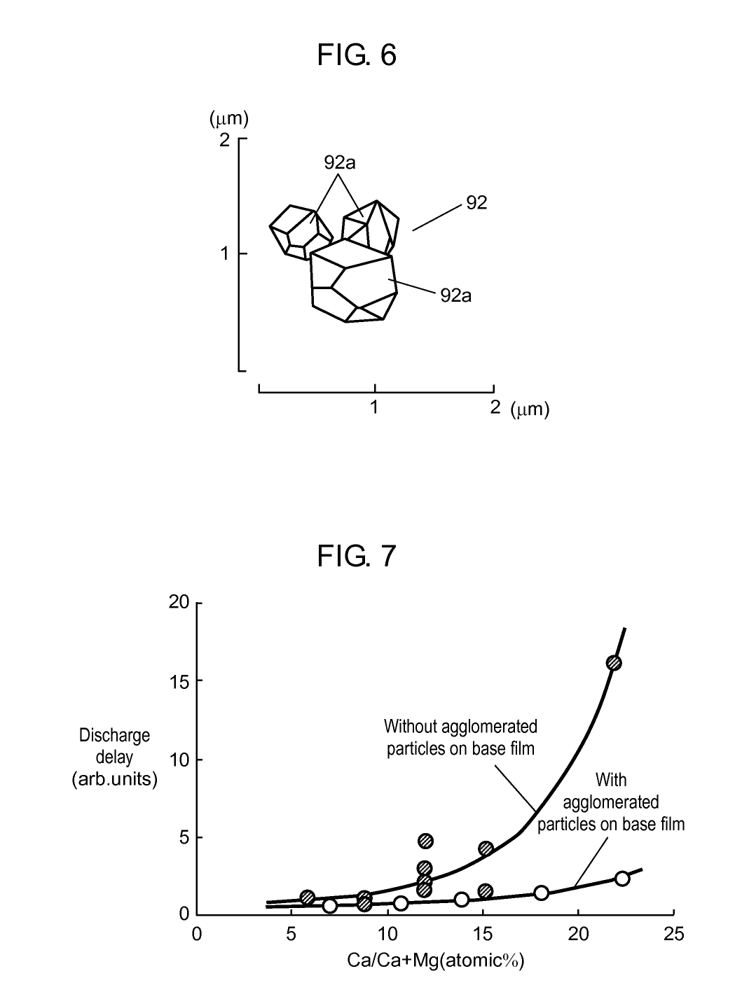

As illustrated in FIG. 6, a plurality of MgO crystal particles 92a agglomerated to one another constitutes agglomerated particle 92. The shape of agglomerated particle 92 can be confirmed by a scan electronic microscope (SEM). According to the present embodiment, agglomerated particles 92 are dispersed evenly on the entire surface of base film 91.

Agglomerated particles 92 each has an average particle diameter in the range of 0.9 μm to 2.5 μm. The average particle diameter recited in the present embodiment is a volume cumulative diameter (D50). To measure the average particle diameter, a particle size distribution measuring apparatus of laser diffraction type, MT-3300 (supplied by NIKKISO CO., LTD.), was used.

Agglomerated particles 92 are not bonded to one another by a strong binding force as a solid matter. Agglomerated particles 92 are an assembly of primary particles gathered by static electricity or van der Waals force. More specifically, agglomerated particles 92 are bound by such an external force, for example, supersonic wave, that all or a part of agglomerated particle 92 is disassembled into primary particles. Agglomerated particles 92 have particle diameters of approximately 1 μm. Crystal particle 92a has a polygonal shape having no less than seven surfaces such as cuboctahedron or dodecahedron. Crystal particle 92a can be produced by vapor phase synthesis or precursor firing technique described below.

In the vapor phase synthesis, a magnesium (Mg) metallic material having a purity no less than 99.9% is heated in an atmosphere filled with an inactive gas, and a small amount of oxygen is added in an atmosphere for further heating, so that Mg is directly oxidized. Thus, MgO crystal particles 92a are obtained.

In the precursor firing technique, crystal particles 92a are obtained by the following technique. In precursor firing technique, an MgO precursor is evenly fired at such a high temperature as no less than 700° C. and then slowly cooled down so that MgO crystal particles 92a are obtained. The precursor is, for example, at least a compound selected from magnesium alkoxide (Mg(OR)₂), magnesium acetyl acetone (Mg(acac)₂), magnesium hydroxide (Mg(OH)₂), magnesium carbonate (MgCO₂), magnesium chloride (MgCl₂), magnesium sulfate (MgSO₄), magnesium nitrate (Mg(NO₃)₂), and magnesium oxalate (MgC₂O₄).

Some of the selected compounds may take the form of hydrate, which can also be used. The selected compound is adjusted so that the purity of MgO after the firing is no less than 99.95% or desirably no less than 99.98%. In the case where at least a certain amount of impurity elements, such as alkali metals, B, Si, Fe, or Al, is included in the selected compound, unnecessary inter-particle cohesion or sintering occurs during the heating process, making it difficult to obtain highly crystalline crystal particles 92a made of MgO. Therefore, it is necessary to adjust the precursor in advance by removing such an impurity element. The firing temperature or firing atmosphere in the precursor firing technique is adjusted so that the particle diameters are adjusted. The firing temperature is selected from the temperature range of approximately 700° C. to 1,500° C. At a firing temperature no less than 1,000° C., the primary particle diameters can be controlled to about 0.3 μm to 2 μm. Crystal particles 92a are obtained in the formation process using the precursor firing technique in the form of agglomerated particles 92 in which the primary particles are agglomerated to one another.

It was confirmed in the tests conducted by the inventors of the present invention that MgO agglomerated particles 92 control a discharge delay mostly in the address discharge and improve a temperature dependency of the discharge delay. The present embodiment, therefore, provides agglomerated particles 92 as an initial electron supplier necessary for a discharge pulse to rise because agglomerated particles 92 exert a better initial electron releasability than base film 91.

A main likely cause of the discharge delay is an insufficient amount of initial electrons to be released as a trigger from the surface of base film 91 into discharge space 16 in an initial stage of the electric discharge. For constant supply of the initial electrons to be released into discharge space 16, MgO agglomerated particles 92 are dispersed on the surface of base film 91. This supplies ample electrons into discharge space 16 during the rise of the discharge pulse, avoiding the discharge delay. As a result of such initial electron releasability, even high-definition PDP 1 can achieve a high-speed drive and a good discharge responsiveness. When agglomerated particles 92 of the metallic oxide are thus provided on the surface of base film 91, the discharge delay which mostly occurs in the address discharge is effectively controlled, and the temperature dependency of the discharge delay can be lessened.

As described so far, PDP 1 according to the present embodiment includes base film 91 which accomplishes a low-voltage drive and a good charge retainability both, and MgO agglomerated particles 92 which effectively prevent a discharge delay. This technical advantage enables PDP 1 with high-definition to be driven fast with a low voltage and to display images with a high quality while avoiding any lighting failure.

[4-3. Test 1]

FIG. 7 is a graph illustrating a relationship between a discharge delay and a calcium (Ca) concentration in protective layer 9 in the case where base film 91 including MgO and CaO is used in PDP 1 according to the present embodiment. Base film 91 includes MgO and CaO. Base film 91 has a peak between a diffraction angle at which the peak of MgO is generated and a diffraction angle at which the peak of CaO is generated through an X-ray diffraction analysis.

FIG. 7 illustrates an example in which base film 91 alone is used as protective layer 9 and an example in which agglomerated particles 92 are provided on base film 91, and base film 91 not including Ca is used as a standard base film to evaluate the discharge delay.

It is clear from FIG. 7 illustrating the example in which base film 91 alone is used and the example in which agglomerated particles 92 are provided on base film 91 that the discharge delay increases as the Ca concentration is elevated in the example in which base film 91 alone is used, whereas the discharge delay is largely reduced, and the discharge delay hardly increases regardless of the elevated Ca concentration in the example in which agglomerated particles 92 are provided on base film 91.

[4-4. Test 2]

Next, results of tests conducted to confirm the effects of PDP 1 having protective layer 9 according to the present embodiment are described.

PDPs 1 having protective layers 9 differently formed were produced as samples. Sample 1 is PDP 1 having MgO protective layer 9 alone. Sample 2 is PDP 1 having MgO protective layer 9 doped with such an impurity as Al or Si. Sample 3 is PDP 1 in which the primary particles alone of MgO crystal particles 92a are dispersed on and adhere to MgO protective layer 9.

Sample 4 is PDP 1 according to the present embodiment. Sample 4 is PDP 1 in which agglomerated particles 92 including MgO crystal particles 92a having equal particle diameters and agglomerated to one another adhere evenly to all over the surface of MgO base film 91. Sample A described earlier is used as protective layer 9. Protective layer 9 has base film 91 including MgO and CaO, and agglomerated particles 92 including crystal particles 92a agglomerated to one another adhere evenly to all over the surface of base film 91. Base film 91 has a peak between the peaks of the first metallic oxide and the second metallic oxide constituting base film 91 in the X-ray diffraction analysis of the surface of base film 91. In other words, the first metallic oxide is MgO, and the second metallic oxide is CaO. The diffraction angle of the peak of MgO is 36.9 degrees, the diffraction angle of the peak of CaO is 32.2 degrees, and the diffraction angle of the peak of base film 91 is 36.1 degrees.

The electron releasability and charge retainability were measured in these PDPs 1 respectively having four different protective layers.

As a numerical value of the electron releasability is larger, more electrons are released. The electron releasability is expressed in the form of an initial electron release amount determined by a discharge surface condition, type of gas, and condition of gas. The initial electron release amount can be measured by measuring an electron current amount released from the surface when ion or electronic beam is irradiated thereon, however, it is difficult to perform the measurement in a non-destructive approach. Therefore, the method disclosed in Unexamined Japanese Patent Publication No. 2007-48733 was used. Of delay times during the electric discharge, a numerical value as an indicator of a degree of dischargeability, called a statistical delay time, was measured. When an inverse number of the statistical delay time is integrated, a numerical value linearly corresponding to the initial electron release amount is obtained. The discharge delay time is a delay time of the address discharge from the rise of the address discharge pulse. A main likely cause of the discharge delay is that there is some difficulty in the release of the initial electrons which trigger the address discharge from the protective layer surface into the discharge space.

An indicator used to evaluate the charge retainability is a voltage value (hereinafter, called Vscn lighting voltage) applied to the scan electrodes to control the charge release when PDP 1 is produced. As the Vscn lighting voltage is lower, the charge retainability is higher because the PDP can be driven with a lower voltage as the Vscn lighting voltage is lower. Because of this advantage, any parts having a lower breakdown voltage and a smaller capacity can be used as a power supply and electric components. Among the products currently available, devices having a breakdown voltage of approximately 150 V are conventionally used as a semiconductor switching element such as MOSFET used for sequential application of the scan voltage to a plate. The Vscn lighting voltage is desirably no more than 120 V in view of temperature-dependent variability.

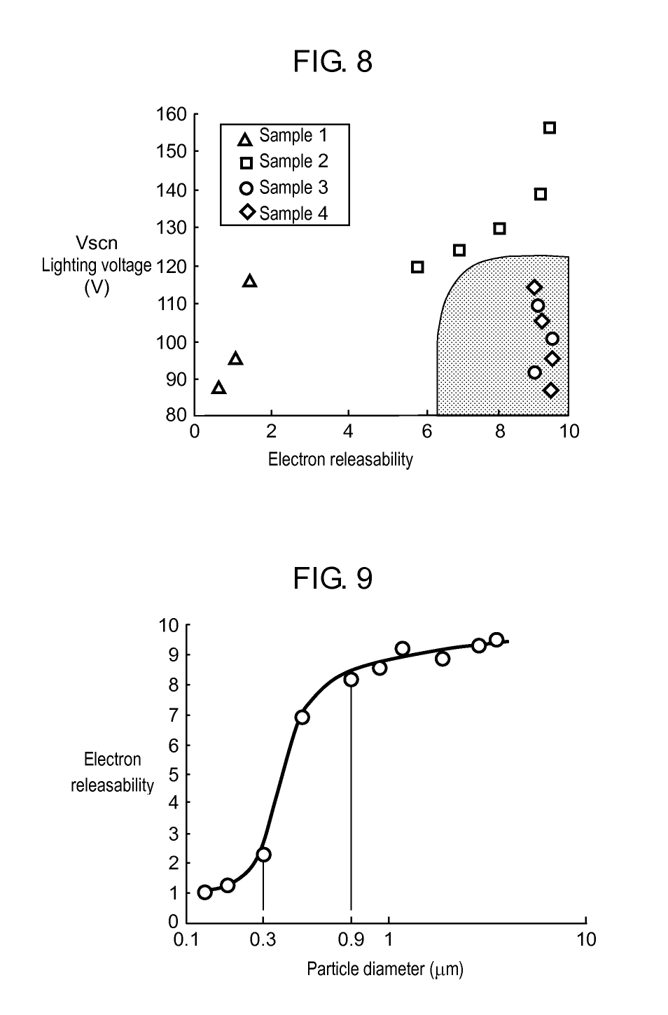

As is clear from FIG. 8, Sample 4 succeeded in reducing the Vscn lighting voltage to no more than 120 V in the evaluation of the charge retainability, and further succeeded in achieving significantly improved characteristics as compared to the electron releasability of Sample 1 in which MgO is the only material of the protective layer.

In general, the electron releasability and the charge retainability of the protective layer in PDP contradict with each other. When, for example, deposition conditions of the protective layer are changed or the protective layer is doped with an impurity such as Al, Si, or Ba to form film, the electron releasability can be improved. This, however, brings an adverse effect, which is increase of the Vscn lighting voltage.

The PDP having protective layer 9 according to the present embodiment can attain the electron releasability no less than 8 and the charge retainability that the Vscn lighting voltage is no more than 120 V. More specifically, protective layer 9 thus obtained has the electron releasability and the charge retainability which are good enough for any PDP wherein there are more scan lines to meet the demand of a higher definition and cells are increasingly downsized.

[4-5. Test 3]

Below is described in detail the particle diameter of agglomerated particles 92 used in protective layer 9 of PDP 1 according to the present embodiment. The particle diameter recited in the following description is an average particle diameter, and the average particle diameter is a volume cumulative diameter (D50).

FIG. 9 illustrates a test result of the electron releasability checked by changing the average particle diameter of MgO agglomerated particles 92 in protective layer 9. Referring to FIG. 9, agglomerated particles 92 were observed by SEM so that the average particle diameter of agglomerated particles 92 was measured.

As illustrated in FIG. 9, the electron releasability declines when the average particle diameter is as small as approximately 0.3 μm. As far as the average particle diameter is no less than approximately 0.9 μm, the electron releasability of an expected level can be obtained.

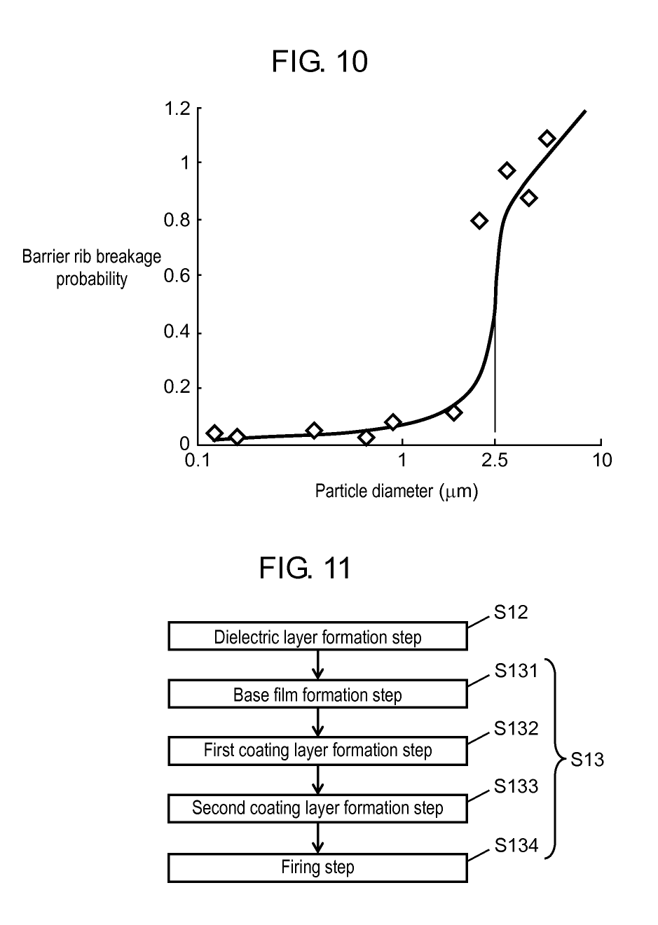

To increase the number of electrons released in the discharge cell, number of crystal particles per unit area of protective layer 9 is desirably larger. It was learnt from the tests conducted by the inventors of the present invention that the top portions of barrier ribs 14 may be broken in the case where crystal particles 92a are present on or near barrier ribs 14 in close contact with protective layer 9, in which case the components of broken barrier ribs 14 might drop on the phosphors, possibly failing to light on or off any relevant cell normally. Such an unfavorable event as the breakage of the barrier rib is unlikely to occur as far as crystal particles 92a are not present at the top portions of the barrier ribs, meaning that the chances of the breakage of barrier ribs 14 are higher as more crystal particles adhere to the layer. FIG. 10 illustrates a test result of the probability of the barrier rib breakage obtained by changing the average particle diameter of agglomerated particles 92. As illustrated in FIG. 10, the probability of the barrier rib breakage soars in the case where the average particle diameter of agglomerated particles 92 is as large as approximately 2.5 μm, whereas the probability of the barrier rib breakage is relatively low as far as the average particle diameter is smaller than 2.5 μm.

As described, PDP 1 having protective layer 9 according to the present embodiment can gain the electron releasability no less than 8 and the charge retainability that the Vscn lighting voltage is no more than 120 V.

The crystal particles described in the present embodiment are MgO particles. A similar effect can be exerted by other single crystal particles, for example, crystal particles obtained from a metallic oxide capable of a high electron releasability similarly to MgO, such as Sr, Ca, Ba, or Al. Therefore, the particles are not necessarily limited to MgO.

### [5. Details of Protective Layer Formation Steps S13]

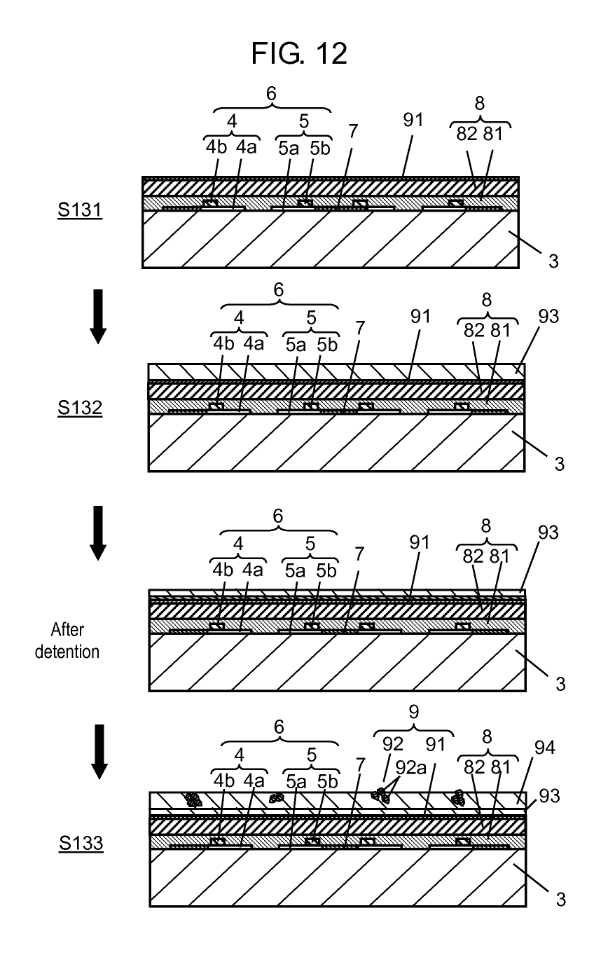

Next, protective layer formation steps S13 according to the present embodiment are described referring to FIGS. 11 and 12.

As illustrated in FIG. 11, protective layer formation steps S13 include base film formation step S131, first coating layer formation step S132, second coating layer formation step S133, and firing step S134 subsequent to dielectric layer formation step S12.

[5-1. Base Film Formation Step S131]

As illustrated in FIG. 12, base film formation step S131 forms base film 91 on dielectric layer 8 by vacuum vapor deposition. A raw material used in the vacuum vapor deposition is a pellet in which MgO, CaO, SrO, and BaO are mixed, or may be a pellet in which MgO alone, CaO alone, SrO alone, or BaO alone is used. In place of the vacuum vapor deposition, sputtering or ion plating, for example, may be employed. In base film formation step S131, base film 91 thus formed may be fired.

Front glass substrate 3 having base film 91 formed thereon is immediately transferred to first coating layer formation step S132.

[5-2. First Coating Layer Formation Step S132]

In first coating layer formation step S132, a first organic solvent is spread on base film 91 so that first coating layer 93 is formed on base film 91. The first organic solvent suitably has a good affinity with base film 91 and a low evaporation rate. The evaporation rate of the first organic solvent is preferably lower than the evaporation rate of butyl acetate. Conventionally, a relative evaporation rate of any organic solvent is measured based on the evaporation rate of butyl acetate. As far as the evaporation rate of the first organic solvent is lower than that of butyl acetate, first coating layer 93 is not easily dehydrated though exposed to the atmosphere. The first organic solvent preferably includes a resin because the resin included in the first organic solvent is left on base film 91 just in case the first organic solvent is dehydrated.

Examples of the first organic solvent are dimethyl methoxy butanol, terpineol, propylene glycol, and benzyl alcohol.

To form first coating layer 93, the first organic solvent is vaporized and sprayed onto base film 91. The first organic solvent is sprayed while front glass substrate 3 transferred from a deposition chamber when base film formation step S131 is over is staying in a cooling chamber or an unloading chamber. First coating layer 93 is formed within ten minutes after base film formation step S131 is over.

To coat base film 91 with first coating layer 93, any of screen printing, spraying, spin coating, die coating, and slit coating may be employed.

The average film thickness of first coating layer 93 is decided in consideration of the first organic solvent and a detention time before second coating layer formation step S133 described later starts. The average film thickness of first coating layer 93 is preferably no less than 1 μm and no more than 10 μm. In the case where the average film thickness of first coating layer 93 is larger than 10 μm, firing step S134 described later unfavorably needs more firing time. A longer firing time demands the improvement of tact time, resulting in increase of a manufacturing cost. Further, it fails to evenly mix first coating layer 93 and second coating layer 94 with each other, deteriorating the dispersibility of agglomerated particles 92. First coating layer 93 having the average film thickness smaller than 1 μm immediately dries off, exposing base film 91.

When first coating layer 93 is thus formed on base film 91, base film 91 exposed to the atmosphere is prevented from reacting with any CO-based impurity present in the atmosphere. In the presence of base film 91, therefore, the secondary electron releasability is prevented from deteriorating.

Therefore, the production method of PDP 1 according to the present embodiment can produce PDP 1 wherein the properties of base film 91 are prevented from deteriorating, and the sustain voltage is reduced.

A conventional PDP production method is described below. According to the protective layer formation steps of the conventional PDP production method, an agglomerated particle paste coating step follows a base film formation step. In the agglomerated particle paste coating step, an agglomerated particle paste, which is an organic solvent including agglomerated particles 92 dispersed therein, is spread on base film 91.

Due to some technical or structural problems of a production facility, however, front glass substrate 3 provided with base film 91 thereon may be detained in some cases for no less than two hours after the base film formation step is over before the agglomerated particle paste coating step starts. During the time, front glass substrate 3 is detained in a stocker for no less than two hours under the ambient atmosphere. When front glass substrate 3 is thus detained in the stocker, base film 91 is exposed to the atmosphere. Base film 91, when exposed to the atmosphere, easily deteriorate its properties through the reaction with the CO-based impurity. As a result of the reaction between the surface of base film 91 and the CO-based impurity, carbonate is formed on the surface of base film 91, and the deteriorated surface of base film 91 diminishes the secondary electron releasability of base film 91. As a result, the conventional PDP production method may increase the PDP sustain voltage. The carbonate formed on the surface of base film 91 is a compound, which cannot be easily removed in the production process. To remove calcium carbonate, for example, formed on the surface of base film 91 through thermolysis, base film 91 should be heated at a temperature no less than 825° C. This raises the need to arrange an additional step other than a simple heat treatment.

To solve the conventional technical problem described so far, the production method of PDP 1 according to the present embodiment performs first coating layer formation step S132 immediately after base film formation step S131 is over. To from first coating layer 93, the first organic solvent is preferably spread on base film 91 within two hours after base film formation step S131 is over, and the first organic solvent is more preferably spread on base film 91 within one hour after base film formation step S131 is over.

The inventors of the present invention obtained the technical finding from the tests that the surface of base film 91 started to change its properties as soon as it was exposed to the atmosphere, and the change of properties on the entire surface thereof was completed within about two hours after that. When first coating layer formation step S132 is performed within two hours after base film formation step S131 is over, the initial sustain voltage is decreased by about 1 V-8 V. When first coating layer formation step S132 is performed within one hour after base film formation step S131 is over, the initial sustain voltage is decreased by about 5 V-8 V. When first coating layer formation step S132 is performed after base film formation step S131 is over without any exposure to the atmosphere, the initial sustain voltage is decreased by about 8 V.

Then, second coating layer formation step S133 is performed after first coating layer formation step S132 is over.

[5-3. Second Coating Layer Formation Step S133]

In second coating layer formation step S133, first, the second organic solvent containing agglomerated particles 92 dispersed therein is prepared. Then, the second organic solvent is spread on first coating layer 93 so that second coating layer 94 having an average film thickness of 8 μm-20 μm is formed. The second organic solvent is spread on first coating layer 93 by, for example, screen printing, spraying, spin coating, die coating, or slit coating. The second organic solvent suitably has a good affinity with agglomerated particles 92 and a high dispersibility for agglomerated particles 92. The second organic solvent, which is spread on first coating layer 93 including the first organic solvent, is not required to meet the affinity with base film 91. Examples of the second organic solvent are methyl methoxy butanol, terpineol, propylene glycol, and benzyl alcohol.

The specific gravity of the second organic solvent is preferably no more than the specific gravity of the first organic solvent. In the case where the specific gravity of the second organic solvent is larger than the specific gravity of the first organic solvent, it fails to evenly intermingle first coating layer 93 and second coating layer 94 in second coating layer formation step S134. Unless first coating layer 93 and second coating layer 94 are evenly intermingled, the dispersibility of agglomerated particles 92 is deteriorated. For the second organic solvent, the material of the first organic solvent may also be used because the same material can avoid the risk of undermining the dispersibility of agglomerated particles 92. The second organic solvent may also include a resin.

As described earlier, the conventional PDP production method spreads second coating layer 94 directly on base film 91 because the method not including first coating layer formation step S132 does not form first coating layer 93. Therefore, the second organic solvent is unexceptionally a material having a good affinity with base film 91 and agglomerated particles 92 and a high dispersibility for agglomerated particles 92, ruling out any organic solvent which may have a high dispersibility for agglomerated particles 92 but lacks an expected affinity with base film 91.

The production method of PDP 1 according to the present embodiment includes first coating layer formation step S132. In first coating layer formation step S132, the second organic solvent is spread on first coating layer 93 including the first organic solvent. Therefore, any organic solvent which may have a high dispersibility for agglomerated particles 92 but lacks an expected affinity with base film 91 can be an option for the material of the second organic solvent. As a result, agglomerated particles 92 can be evenly dispersed in the second organic solvent and then evenly dispersed on base film 91. The production method of PDP 1 according to the present embodiment can produce PDP 1 achieving a uniform luminance.

Front glass substrate 3 having first coating layer 93 and second coating layer 94 formed thereon is then transferred to firing step S134.

[5-4. Firing Step S134]

In firing step S134, first coating layer 93 formed on base film 91 and second coating layer 94 formed further thereon are heated so that the first organic solvent and the second organic solvent are evaporated. As a result, agglomerated particles 92 are dispersed on base film 91.

First, front glass substrate 3 where second coating layer 94 is formed on first coating layer 93 is transported to a baking oven. The baking oven is evacuated and heated so that its internal temperature rises until the temperature of front glass substrate 3 placed therein reaches, for example, approximately 370° C. Front glass substrate 3 is then detained to stay at the temperature for about 10 to 20 minutes so that the first organic solvent and the second organic solvent are evaporated. As a result of the evaporation of the first organic solvent and the second organic solvent, agglomerated particles 92 are dispersed on base film 91. In the case where the first organic solvent and the second organic solvent include a resin component, the resin component is fired as well.

Base film 91 formed in base film formation step S131 but still unfired is fired in firing step S134 alongside first coating layer 93 and second coating layer 94.

A drying step may be performed prior to firing step S134. The drying step alleviates a workload associated with the maintenance of the baking oven because an amount of the first and second organic solvents evaporated in firing step S134 can be decreased. When first coating layer 93 and second coating layer 94 are dried in the drying step, the first and second organic solvents are evaporated so that agglomerated particles 92 are dispersed on base film 91. During the drying step, all of the first and second organic solvents are not dehydrated but some of the solvents remains on base film 91. A preferable example of the drying technique is vacuum drying. More specifically, the internal pressure of the vacuum chamber is reduced to approximately 10 Pa within about two minutes to rapidly dry first coating layer 93 and second coating layer 94. Such a vacuum drying does not generate convection in a film which is a prominent phenomenon of heat dry. Therefore, agglomerated particles 92 can adhere more evenly to base film 91. However, heat dry is a possible drying option.

Firing step S134 may be performed at the same time as sealing and evacuation step S32 illustrated in FIG. 3. When front plate 2 and rear plate 10 are heated in sealing and evacuation step S32, first coating layer 93 and second coating layer 94 are heated at the same time so that the first organic solvent and the second organic solvent are dehydrated.

[5-5. Test 4]

Below are described a result of a test conducted to confirm the effects of the PDP 1 production method according to the present embodiment. The inventors of the present invention prepared three different PDP samples in which the composition of base film 91 and protective layer formation steps S13 were changed. The inventors measured the initial sustain voltages of the samples. In the production process of PDP of Sample 1, first coating layer formation step S132 was not performed, and base film 91 including MgO alone was formed in base film formation step S131. In the production process of PDP of Sample 2, first coating layer formation step S132 was not performed, and base film 91 of the sample A was formed in base film formation step S131. Base film 91 of Sample 2, therefore, includes MgO and CaO. In the production process of PDP of Sample 3, first coating layer formation step S132 was performed, and base film 91 of the sample A was formed in base film formation step S131. First coating layer formation step S132 was performed within 10 minutes after base film formation step S131 ended. Terpineol was used as the first and second organic solvents. The PDPs of the samples 1 and 2 were both detained under the ambient atmosphere for about three hours after base film formation step S131 ended until second coating layer formation step S133 started. The PDP of the sample 3 was detained under the ambient atmosphere for about three hours after first coating layer formation step S132 ended until second coating layer formation step S133 started.

The initial sustain voltages of these samples 1 to 3 were measured, and the relative sustain voltages thereof based on the voltage value of sample 1 were measured. The relative sustain voltage of the PDP of Sample 2 was −21.6 (V) based on the sustain voltage of the PDP of Sample 1=0 (V). It is known that the PDP of Sample 2 significantly lowered the sustain voltage as compared to the PDP of Sample 1. Such a sustain voltage reduction can be accomplished because base film 91 of the PDP of Sample 2 includes MgO and CaO. Thus, the PDP of Sample 2 can have a lower sustain voltage because base film 91 includes two different metallic oxides. The relative sustain voltage of the PDP of Sample 3 was −29.7 (V) based on the sustain voltage of the PDP of Sample 1=0 (V). It is known that the PDP of Sample 3 significantly lowered the sustain voltage as compared to the PDP of Sample 2 and the PDP of Sample 1 both. This is the effect obtained by forming first coating layer 93 including the organic solvent on base film 91 in first coating layer formation step S132. First coating layer 93 formed on base film 91 effectively prevents any CO-based impurity from adhering to the surface of base film 91 when the surface is exposed to the atmosphere. As a result, PDP 1 of the sample 3 can avoid the change of properties in base film 91 and thereby reduce the sustain voltage.

In the production method of PDP 1 according to the present embodiment wherein first coating layer 93 is formed in first coating layer formation step S132, it is unnecessary to arrange such as gas atmosphere as vacuum, nitrogen gas, mixed gas containing nitrogen and oxygen, or rare gas for the transportation of front glass substrate 3 having base film 91 formed thereon, simplifying a production facility. When front glass substrate 3 having base film 91 formed thereon is detained in the stocker after base film formation step S131, the change of properties in base film 91 is controlled, and the sustain voltage is thereby reduced.

### [6. Conclusion]

The technology disclosed herein relates to a production method of PDP 1. PDP 1 includes rear plate 10 and front plate 2 disposed so as to face rear plate 10. Front plate 2 includes dielectric layer 8 and protective layer 9 which covers dielectric layer 8. Protective layer 9 includes base film 91 which is a base layer formed on dielectric layer 8. Agglomerated particles 92 in which crystal particles of magnesium oxide are agglomerated to one another are dispersed evenly on an entire surface of base film 91. Base film 91 includes at least a first metallic oxide and a second metallic oxide. Base film 91 further has at least a peak through an X-ray diffraction analysis. The peak of base film 91 is present at an intermediate position between a first peak through an X-ray diffraction analysis of the first metallic oxide and a second peak through an X-ray diffraction analysis of the second metallic oxide. The first peak and the second peak indicate a plane orientation equal to a plane orientation indicated by the peak of the base layer. The first metallic oxide and the second metallic oxide are two selected from a group consisting of magnesium oxide, calcium oxide, strontium oxide, and barium oxide.

The method for producing PDP 1 according to the present embodiment includes the steps of: forming base film 91 on dielectric layer 8; spreading the first organic solvent on base film 91 to form first coating layer 93; spreading the second organic solvent including agglomerated particles 92 dispersed therein on first coating layer 93 to form second coating layer 94 thereon; and heating first coating layer 93 and second coating layer 94 to evaporate the first and second organic solvents and further to disperse agglomerated particles 92 on base film 91.

The production method of PDP 1 according to the present embodiment including these production steps can produce PDP 1 wherein the change of properties does not occur in base film 91 and the sustain voltage can be reduced. Further, the production method of PDP 1 according to the present embodiment can produce PDP 1 wherein luminance uniformity is further improved.

### INDUSTRIAL APPLICABILITY

The technology disclosed in the present embodiment is useful in realizing low power PDP having a display performance with a higher definition and a higher luminance.

### REFERENCE MARKS IN THE DRAWINGS

1 PDP
2 front plate
3 front glass substrate
4 scan electrode
4a, 5a transparent electrode
4b, 5b bus electrode
5 sustain electrode
6 display electrode
7 black stripe
8 dielectric layer
9 protective layer
10 rear plate
11 rear glass substrate
12 data electrode
13 base dielectric layer
14 barrier rib
15 phosphor layer
16 discharge space
81 first dielectric layer
82 second dielectric layer
91 base film
92 agglomerated particles
92a crystal particles
93 first coating layer
94 second coating layer

1. A method for producing a plasma display panel having a rear plate and a front plate disposed so as to face the rear plate, wherein
the front plate includes a dielectric layer and a protective layer which covers the dielectric layer, the protective layer including a base layer formed on the dielectric layer,
agglomerated particles in which crystal particles of magnesium oxide are agglomerated to one another are dispersed evenly on an entire surface of the base layer,
the base layer includes at least a first metallic oxide and a second metallic oxide, and has at least a peak through an X-ray diffraction analysis,
the peak of the base layer is present at an intermediate position between a first peak through an X-ray diffraction analysis of the first metallic oxide and a second peak through an X-ray diffraction analysis of the second metallic oxide,
the first peak and the second peak indicate a plane orientation equal to a plane orientation indicated by the peak of the base layer, and
the first metallic oxide and the second metallic oxide are two selected from a group consisting of magnesium oxide, calcium oxide, strontium oxide, and barium oxide,
the method for producing the plasma display panel comprising:
forming the base layer on the dielectric layer; then
spreading a first organic solvent on the base layer to form a first coating layer; next
spreading a second organic solvent in which the agglomerated particles are dispersed on the first coating layer to form a second coating layer; and then
heating the first and second coating layers to evaporate the first and second organic solvents and further to disperse the agglomerated particles on the base layer.

2. The method for producing the plasma display panel according to claim 1, comprising:
forming the first coating layer within two hours after the base layer is formed.

3. The method for producing the plasma display panel according to claim 2, comprising:
forming the first coating layer within one hour after the base layer is formed.

4. The method for producing the plasma display panel according to claim 1, wherein
the first organic solvent includes a resin, and
the first coating layer and the second coating layer are heated to evaporate the resin, the first organic solvent, and the second organic solvent, and the agglomerated particles are dispersed on the base layer.

5. The method for producing the plasma display panel according to claim 1, wherein
the second organic solvent to have a specific gravity no more than a specific gravity of the first organic solvent.
